(19) United States
(12) Patent Application Publication
(10) Pub. No.: US 2017/0247067 A1
(43) Pub. Date: Aug. 31, 2017

(54) TELESCOPING AXLE FOR A VEHICLE

(71) Applicant: J. & M. Manufacturing Co., Inc., Fort Recovery, OH (US)

(72) Inventor: Joshua P. Gaerke, Fort Recovery, OH (US)

(21) Appl. No.: 15/055,969

(22) Filed: Feb. 29, 2016

(51) Int. Cl. B62D 49/06; B60B 35/16; B60G 9/00

(52) U.S. Cl. CPC B62D 49/0678; B60G 9/00; B60B 35/16; B60G 2200/34

(57) ABSTRACT

A telescoping axle includes an elongated center tubular base axle section for supporting a farm implement and receiving in telescopic relation an elongated tubular outer axle section which receives in telescopic relation an elongated tubular inner axle section. Each axle section is preferably rectangular or square in cross section with the outer and inner axle sections each supporting a horizontal wheel axle. An elongated actuator connects the inner axle section to the outer axle section for moving the inner axle section and outer axle section between a retracted position within the base axle section and an extended position projecting from opposite ends of the base axle section. The axis of each axle is preferably above the base axle section, additional axle sections may be used and the axles may be made steerable.

### BACKGROUND OF THE INVENTION

The present invention is directed to an improved telescoping axle especially suited for use with farm implements, such as, for example, a grain cart or wagon which is pulled by a tractor along a road and also through an un-level field or terrain and which may also be transported on a road by a flat bed trailer or truck. When such an implement or vehicle is transported down a road, the overall width limit for the wheels and vehicle is frequently twelve feet or three meters. When the implement or vehicle is transported or pulled within a field or over an un-level terrain, a wider wheel base is desirable to provide and avoid tipping of the implement or vehicle.

It is known to use telescoping axles on farm implements or vehicles, for example, as disclosed in U.S. Pat. No. 4,040,643, No. 4,379,571, No. 5,326,128 and No. 7,163,227. The general construction of these telescoping axles includes an elongated tubular center section which supports the load on the vehicle. The center section has opposite end portions which slidably receive tubular axle extensions that are substantially identical in size. The axle extensions slide within opposite end portions of the center section between retracted positions and extended positions to position the axles supporting the wheels between retracted and extended positions. The construction of these telescoping axles limits the extent of telescoping and thus limits the distance the axles and wheels may be extended from their retracted positions. For example, the extension of telescoping may be a maximum of twenty four inches.

### SUMMARY OF THE INVENTION

The present invention is directed to an improved telescoping axle which is ideally suited for use on a farm implement such as a grain cart of wagon which is pulled or transported down a road and is also frequently used in a field having a rough or un-level terrain. The telescoping axle of the invention substantially increases the distance for extending the wheel axles from retracted positions to the extended positions, for example, between eighty inches and one hundred and twenty inches on tire centers. In general, the telescoping axle of the invention includes an elongated center base axle section to which are attached members which support the load carried by the vehicle, such as a large container for receiving grain.

The base axle section receives an elongated outer axle section for telescopic linear movement and has a length generally the same as the length of the base axle section. The outer axle section receives a somewhat smaller elongated inner axle section for telescopic linear movement and which has a length generally the same as the length of the outer axle section so that the inner axle section is received within the outer axle section which is received within the base axle section. The outer end portions of the outer axle section and the inner axle section support the wheel axles which are preferably positioned to be in axial alignment above the base axle section. An actuator is enclosed within the inner axle section and is preferable in the form of a fluid or hydraulic cylinder which connects the outer axis section to the inner axle section for simultaneous movement of the axle sections between their retracted positions within the base section and extended positions projecting from the base section.

### BRIEF DESCRIPTION OF THE DRAWINGS

FIG. 1 is a perspective view of a telescoping axle constructed in accordance with the invention and shown in a retracted condition;

FIG. 2 is a perspective view of the axle in FIG. 1 and shown in its extended condition;

FIG. 3 is a vertical axial section in perspective of the axle shown in FIG. 1 in its retracted condition; and

FIG. 4 is a vertical axial section in perspective of the axle shown in FIG. 2 in its extended condition; and

### DESCRIPTION OF THE PREFERRED EMBODIMENT

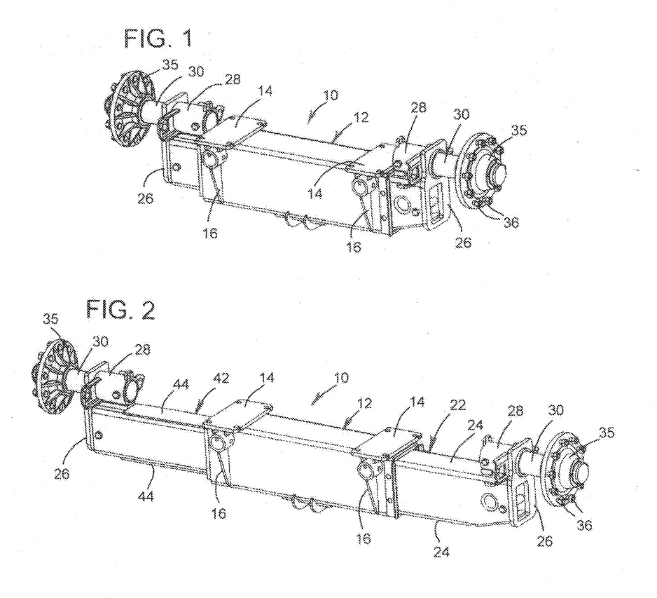

The telescoping axle 10 shown on in FIGS. 1-4 includes an elongated tubular center or base section 12 fabricated from sheet steel and having a rectangular vertical cross-section. Opposite end portions of the base section 12 has horizontal pads or plates 14 which support the frame of a farm implement such as, for example, a grain container of a two wheel grain cart as disclosed in U.S. Pat. No. 9,113,598 which issued to the assignee of the present invention or a container for a four wheel grain wagon as disclosed in U.S. Pat. No. 7,350872 which also issued to the assignee of the present invention. The base section 12 also has a set of socket brackets 16 which are also used for supporting the farm implement.

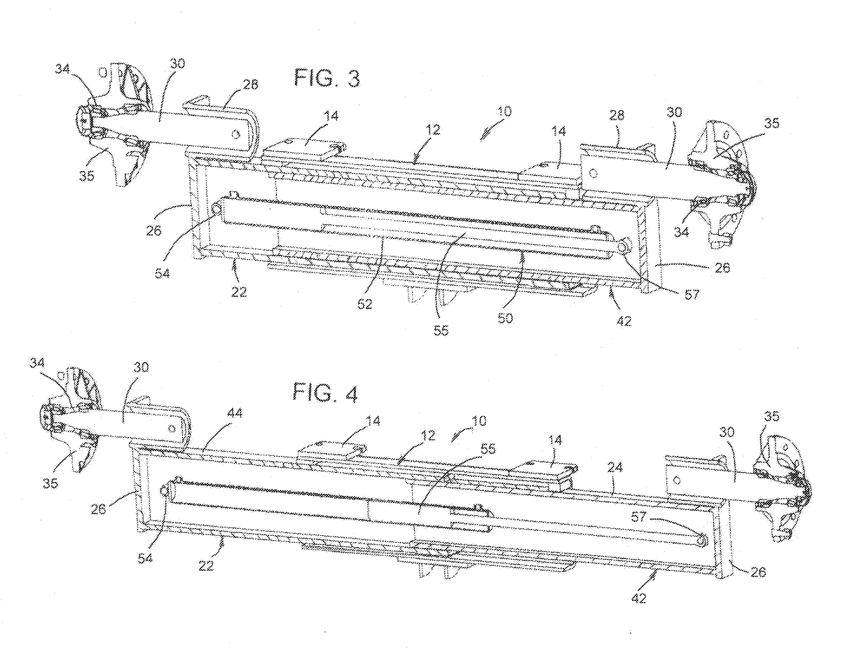

An elongated tubular insert or outer axle section 22 extends into the tubular base section 12 and is slidably received in telescopic relation. The top and bottom surfaces of a axle section 22 have elongated steel strips 24 (FIG. 2) which provide for low friction sliding movement of the axle section 22 within the base axle section 12. As shown in FIG. 3, the length of the outer axle section 22 is about the same as the length of the center base section 12, and the outer end portion of the axle section 22 supports a vertical plate or bracket 26 which supports a cylindrical hub 28 for a non-rotating horizontal axle 30. The outer end portion of the axle 30 is tapered and supports a wheel hub 35 through a set of anti-friction bearings 34 for free rotation of the wheel hub 35 which has peripherally spaced bolts 36 for attaching a wheel.

An elongated tubular insert or inner axle section 42 is slidable longitudinally in telescopic relation within the outer axle section 22 and has a length about the same as the center base section 12 and slightly less than the length of the outer axle section 22. The inner axle section 42 also has elongated steel strips 44 to provide for low friction sliding movement of the inner axle section 42 within the outer axle section 22. The outer end portion of the inner axle section 42 also has a vertical bracket 26 which projects upwardly to support a cylindrical hub 28 for a second axle 30 having an axis aligned with the axis of the first axle 30 with the axis located above the base axle section 12. The second axle 30 also supports a set of anti-friction bearings 34 for a second wheel hub 35.

As shown in FIGS. 3-4, an elongated linear actuator 50 extends longitudinally within the outer axle section 22 and the inner axle section 42. While different forms of actuators may be used, the preferred form is an elongated fluid or hydraulic cylinder having a tubular housing 52 with one end connected to an outer end portion of the outer axle section 22 by a fitting 54. An elongated piston rod 55 extends from the opposite end of the housing 52 and is connected by a fitting 57 to the outer end portion of the inner axle section 42. Operation of the fluid cylinder or actuator 50 causes the telescoping axle 10 to move between its retracted position shown in FIGS. 1 & 3 and its extended position shown in FIGS. 2 & 4. Stops or bands may be used for limiting the travel or longitudinal movement of the inner axle section 42 within the outer axle section 22, and similar stops or bands may be used for limiting longitudinal movement of the outer axle section 22 within the base axle section 12. The stroke of the actuator cylinder 50 may also be used to limit the outward movement of the inner and outer axle sections.

From the drawings and the above description, it is apparent that a telescoping axle constructed in accordance with the invention provides the desirable feature and advantage of significantly increasing the distance of telescoping movement of the axle 10. For example, when the axle 10 is used to transport a vehicle, such as a grain cart, for road travel, the axle may be shifted to its retracted position to provide, for example, an 80 inch between tire centers. However, when it is necessary for the grain cart to travel on un-level terrain, the axle may be shifted to it's extended position when tire centers expand to 120 inches for more stability, especially in a field. Thus the axle 10 provides a substantial telescoping advantage, for example, at least 16 inches over other known telescoping axles such as disclosed in the above mentioned patents referred to in paragraph [0002]. It is also within the scope of the invention to support the wheel axles 30 for steering in response to a pivot able tongue on a wagon or to incorporate additional telescoping axle sections to provide an additional increase in the expanded tire centers.

While the form of telescoping axle herein described constitutes a preferred embodiment of the invention, it is to be understood that the invention is not limited to this precise form of construction, and that changes made therein without departing from the scope of the invention as defined by the appended claims.

What is claimed is:

1. A telescoping axle adapted to support wheels on a farm implement and expandable from a retracted position for road travel to an extended position for use on unlevel terrain, said axle comprising
an elongated center base axle section adapted to support the implement,
an elongated first axle section supported for telescopic linear movement by said base axle section and supporting a horizontal first axle,
an elongated second axle section supported for telescopic linear movement within said first axle section and supporting a horizontal second axle,
said first axle section being movable longitudinally within said base axle section and said second axle section being movable longitudinally within said first axle section, and
means for moving said first axle section and said second axle section between a retracted position within said base axle section and an extended position projecting from opposite ends of said base axle section.

2. An axle as defined in claim 1 wherein said base axle section, said first axle section and said second axle section are each tubular with said first axle section slidable longitudinally within said base axle section and said second axle section slidable longitudinally within said first axle section.

3. An axle as defined in claim 2 wherein each of said base axle section, said first axle section and said second axle section is rectangular or square in cross-sectional configuration.

4. An axle as defined in claim 1 wherein said means for moving sad first axle section and said second axle section comprise elongated fluid cylinder connecting said first axle section to sad second axe section.

5. An axle as defined in claim 4 wherein said fluid cylinder extends longitudinally within both said first axle section and said second axle section.

6. An axle as defined in claim 1 wherein said first axle and said second axle are supported in axial alignment above said base axle section by brackets connected to corresponding end portions of said first axle section and said second axle section.

7. An axle as defined in claim 1 wherein outer end portions of said first axle section and said second axle section include brackets supporting said first axle and said second axle above said base section.

8. An axle as defined in claim 7 wherein said base axle section includes support members secured to opposite end portions of said base section and adapted to support a grain container of said farm implement.

9. A telescoping axle adapted to support wheels on a farm implement and expandable from a retracted position for road travel to an extended position for use unlevel terrain, said axle comprising
an elongated tubular base section adapted to support the farm implement,
an elongated tubular outer axle section supported for telescopic linear movement within said base section and having an end portion supporting a horizontal first axle,
an elongated tubular inner axle section supported for telescopic linear movement within said tubular outer axle section and having an end portion supporting a horizontal second axle,
said tubular outer axle section being movable longitudinally within said tubular base section and said tubular inner axle section being movable longitudinally within said outer axle section, and
an actuator connected to move said outer axle section and said inner axle section between a retracted position within said base section and an extended position projecting from opposite ends of said base section.

10. An axle as defined in claim 9 wherein said tubular base section, said tubular outer axle section and said tubular inner axle section each have a rectangular or square cross-sectional configuration.

11. An axle as defined in claim 9 wherein said actuator comprises an elongated fluid cylinder connecting said tubular inner axle section to said tubular outer axle section.

12. An axle as defined in claim 11 wherein said fluid cylinder extends longitudinally within both said tubular inner axle section and said tubular outer axle section.

13. An axle as defined in claim 9 wherein said first axle and said second axle are supported in axial alignment by brackets mounted on outer end portions of said outer axle section and said inner axle section.

14. An axle as defined in claim 9 wherein said outer end portion of said outer axle section and said outer end portion of said inner axle section include brackets supporting the corresponding said axle above said base section.

15. An axle as defined in claim 9 wherein said tubular base section includes support members secured to opposite end portions of said base section and adapted to support a grain container of said farm implement.
